(19) United States
(12) Patent Application Publication
(10) Pub. No.: US 2012/0131901 A1
(43) Pub. Date: May 31, 2012

(54) SYSTEM AND METHOD FOR CONTROLLING A PULSE DETONATION ENGINE

(75) Inventors: Eric Richard Westervelt, Niskayuna, NY (US); Narendra Digamber Joshi, Niskayuna, NY (US); Adam Rasheed, Glenville, NY (US); Venkat Eswarlu Tangirala, Niskayuna, NY (US)

(73) Assignee: General Electric Company, Schenectady, NY (US)

(21) Appl. No.: 12/956,868

(22) Filed: Nov. 30, 2010

(51) Int. Cl. F02K 7/06; F02K 7/02

(52) U.S. Cl. 60/204; 60/247; 60/248

(57) ABSTRACT

In one embodiment, a pulse detonation engine (PDE) includes a controller configured to receive signals indicative of at least one of a desired operating parameter of the PDE and a measured internal parameter of the PDE, and to adjust at least one of a first fluid flow through the PDE and a second fluid flow through at least one of multiple pulse detonation tubes disposed within the PDE based on the signals. The PDE does not include a turbine or a mechanical compressor.

### BACKGROUND OF THE INVENTION

The subject matter disclosed herein relates generally to a pulse detonation engine and, more specifically, to a system and method for controlling a pulse detonation engine.

Pulse detonation combustion can be utilized in various practical engine applications. An example of such an application is the development of a pulse detonation engine (PDE) where hot detonation products are directed through an exit nozzle to generate thrust for aerospace propulsion. Pulse detonation engines that include multiple combustor chambers are sometimes referred to as a “multi-tube” configuration for a pulse detonation engine. Another example is the development of a “hybrid” engine that uses both conventional gas turbine engine technology and pulse detonation (PD) technology to enhance operational efficiency. Such pulse detonation turbine engines (PDTE) can be used for aircraft propulsion or as a means to generate power in ground-based power generation systems.

Within a pulse detonation tube, the combustion reaction is a detonation wave that moves at supersonic speed, thereby increasing the efficiency of the combustion process as compared to subsonic deflagration combustion. Specifically, air and fuel are typically injected into the pulse detonation tube in discrete pulses. The fuel-air mixture is then detonated by an ignition source, thereby establishing a detonation wave that propagates downstream through the tube at a supersonic velocity. In addition, a weaker shockwave may propagate upstream toward the combustor inlet. The detonation process produces pressurized exhaust gas within the pulse detonation tube that may be used to produce thrust or be converted to work in a turbine.

Certain PDEs include an inlet, an array of pulse detonation tubes positioned downstream from the inlet, and an exit nozzle positioned downstream from the array of pulse detonation tubes. In such configurations, forward movement of the PDE drives ambient air into the inlet where the air is compressed due to the inlet geometry. The compressed air then flows to the pulse detonation tubes. A valve attached to an upstream end of each tube periodically opens to fill the pulse detonation tube with an air charge. Fuel is injected into the air charge, and the mixture is detonated to produce pressurized exhaust gas. The exhaust gas is directed toward the exit nozzle which accelerates the flow to produce thrust. By periodically firing each pulse detonation tube within the array, a substantially constant thrust may be generated. The thrust produced by the PDE drives the PDE forward, thereby providing the inlet with the desired airflow. Because the PDE configuration described above does not include a mechanical compressor or a turbine, the PDE may be known as a “pure” PDE.

Certain pure PDEs may be employed to propel an aircraft. As will be appreciated, establishing a desired thrust facilitates various phases of aircraft operation. For example, a higher thrust may be desired to propel the aircraft during takeoff, while a lower thrust may be desired during landing. It should also be appreciated that environmental conditions, such as ambient temperature, pressure, humidity, etc., may vary throughout the flight phases, and may influence PDE performance. Consequently, it may be desirable to control operation of a pure PDE to enable variations in thrust and/or to compensate for changing environmental conditions.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a pulse detonation engine (PDE) includes a controller configured to receive signals indicative of at least one of a desired operating parameter of the PDE and a measured internal parameter of the PDE, and to adjust at least one of a first fluid flow through the PDE and a second fluid flow through at least one of multiple pulse detonation tubes disposed within the PDE based on the signals. The PDE does not include a turbine or a mechanical compressor.

In another embodiment, a PDE includes an inlet disposed at an upstream end of the PDE and configured to receive an airflow from ambient air. The PDE also includes multiple pulse detonation tubes positioned downstream from the inlet. Each pulse detonation tube is configured to receive the airflow from the inlet, and the PDE does not include a mechanical compressor positioned between the inlet and the pulse detonation tubes. The PDE further includes a controller configured to receive signals indicative of at least one of a desired operating parameter of the PDE and a measured internal parameter of the PDE, and to adjust at least one of a first fluid flow through the PDE and a second fluid flow through at least one of the pulse detonation tubes based on the signals.

In a further embodiment, a method for operating a PDE which does not include a mechanical compressor or a turbine includes receiving signals indicative of at least one of a desired operating parameter of the PDE and a measured internal parameter of the PDE. The method also includes adjusting at least one of a first fluid flow through the PDE and a second fluid flow through at least one of multiple pulse detonation tubes disposed within the PDE based on the signals.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an embodiment of a pulse detonation engine including a controller configured to control operation of the pulse detonation engine;

FIG. 2 is a schematic diagram of an embodiment of a pulse detonation tube that may be used within the pulse detonation engine of FIG. 1;

FIG. 3 is a schematic diagram of an embodiment of a pulse detonation engine in which the pulse detonation tubes are configured to exhaust directly to ambient;

FIG. 4 is a schematic diagram of an embodiment of a pulse detonation engine in which the inlet includes a movable spike; and

FIG. 5 is a flowchart of an embodiment of a method for controlling a pulse detonation engine.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As used herein, a pulse detonation tube is understood to mean any device or system that produces both a pressure rise and velocity increase from a series of repeated detonations or quasi-detonations within the tube. A “quasi-detonation” is a supersonic turbulent combustion process that produces a pressure rise and velocity increase higher than the pressure rise and velocity increase produced by a deflagration wave. Embodiments of pulse detonation tubes include a means of igniting a fuel/oxidizer mixture, for example a fuel/air mixture, and a detonation chamber, in which pressure wave fronts initiated by the ignition process coalesce to produce a detonation wave or quasi-detonation. Each detonation or quasi-detonation is initiated either by external ignition, such as spark discharge or laser pulse, or by gas dynamic processes, such as shock focusing, auto ignition or by another detonation (i.e. cross-fire). As used herein, detonation is used to mean either a detonation or quasi-detonation.

Embodiments disclosed herein may enable operator control of a pulse detonation engine (PDE) and/or facilitate efficient PDE operation despite variations in environmental conditions. For example, in one embodiment, a PDE includes an inlet disposed at an upstream end of the PDE and configured to receive an airflow from ambient air. The PDE also includes multiple pulse detonation tubes positioned downstream from the inlet. Each pulse detonation tube is configured to receive the airflow from the inlet, and the PDE does not include a mechanical compressor positioned between the inlet and the pulse detonation tubes. Furthermore, the PDE includes a controller configured to receive signals indicative of at least one of a desired operating parameter of the PDE and a measured internal parameter of the PDE, and to adjust at least one of a first fluid flow through the PDE and a second fluid flow through at least one of the pulse detonation tubes based on the signals. For example, the signals indicative of the desired operating parameter may include a thrust, a specific impulse and/or a composition of exhaust gas, and the signals indicative of the measured internal parameter may include temperature and/or pressure measured at various locations within the PDE. In certain embodiments, the controller may be configured to adjust the fluid flow through the PDE by varying the geometry of the inlet, by varying the geometry of an exit nozzle positioned downstream from the pulse detonation tubes, by varying the geometry of at least one pulse detonation tube nozzle, by varying a firing pattern of the pulse detonation tubes, by selectively deactivating at least one pulse detonation tube, and by selectively opening and closing certain bypass valves. In addition, the controller may be configured to adjust the fluid flow through at least one of the pulse detonation tubes by varying an opening frequency of an air valve disposed at an upstream end of the pulse detonation tube, by varying an opening duration of the air valve, by varying an injection pressure of fuel into the pulse detonation tube, by varying an injection duration of the fuel, by varying a time difference between opening the air valve and injecting the fuel, and by varying a time difference between opening the air valve and igniting a fuel-air mixture within the pulse detonation tube. By monitoring measured internal parameters of the PDE, the controller may adjust fluid flow through the PDE and/or fluid flow through at least one of the pulse detonation tubes to compensate for changing environmental conditions. In addition, the controller may adjust fluid flow through the PDE and/or fluid flow through at least one of the pulse detonation tubes to establish a desired operating parameter (e.g., thrust, specific impulse and/or exhaust gas composition) input through a user interface.

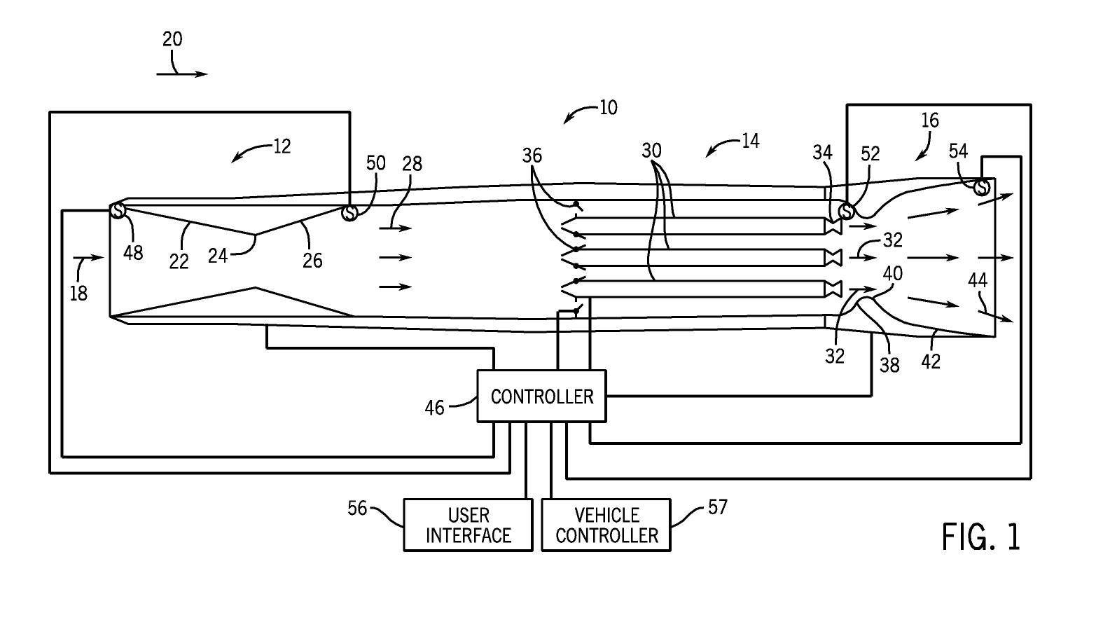

FIG. 1 is a schematic diagram of an embodiment of a PDE 10 including a controller configured to control operation of the PDE. In the illustrated embodiment, the PDE 10 includes an inlet 12, a pulse detonation combustor 14, and an exit nozzle 16. During operation, forward movement of the PDE 10 through ambient air will establish an airflow 18 into the inlet 12 along a downstream direction 20. As illustrated, the inlet 12 includes a converging section 22, a throat 24 and a diverging section 26. If the speed of the airflow 18 into the inlet 12 is greater than the speed of sound (i.e., supersonic flow), the geometry of the converging section 22, the throat 24 and the diverging section 26 may be particularly configured to transition the low-pressure supersonic airflow 18 into a high pressure subsonic airflow 28 through a series of oblique shocks followed by a terminal normal shock just downstream of the throat. Furthermore, the diverging section 26 may be shaped to further decrease the velocity of the airflow 18 while increasing pressure within the PDE 10 (i.e., converting the dynamic head to a pressure head). Such an inlet configuration may provide a high-pressure subsonic airflow 28 to the pulse detonation combustor 14, while substantially reducing shockwave formation that may otherwise reduce the efficiency of the supersonic-to-subsonic transition.

As illustrated, the high-pressure subsonic airflow 28 is directed toward an array of pulse detonation tubes 30 within the pulse detonation combustor 14. In the illustrated embodiment, the pulse detonation combustor 14 includes three pulse detonation tubes 30. However, it should be appreciated that alternative embodiments may include more or fewer pulse detonation tubes 30. For example, certain embodiments may include 2, 3, 4, 5, 6, 7, 8, 9, 10, or more pulse detonation tubes 30. As discussed in detail below, a valve attached to an upstream end of each tube 30 periodically opens to fill the pulse detonation tube 30 with an air charge. Fuel is injected into the air charge, and the mixture is detonated to produce pressurized exhaust gas. As illustrated, the exhaust gas 32 is expelled through nozzles 34 which accelerate the flow, and direct the exhaust gas 32 toward the exit nozzle 16. By periodically firing each pulse detonation tube 30 within the array, a substantially constant thrust may be generated.

In the illustrated embodiment, the PDE 10 includes multiple bypass valves 36 positioned between adjacent pulse detonation tubes 30. The bypass valves 36 are configured to selectively open and close to adjust airflow through the PDE 10. For example, if a higher thrust is desired, the pulse detonation tubes 30 may receive a higher air flow rate. In such a configuration, the bypass valves 36 may be transitioned to a closed position, thereby directing a large portion of the high-pressure air 28 into the pulse detonation tubes 30. However, if a lower thrust is desired, the air flow into the pulse detonation tubes 30 may be reduced. Consequently, the bypass valves 36 may be transitioned to an open position, thereby relieving a backpressure that may otherwise develop upstream of the pulse detonation tubes 30 due to the disparate flow rates between the inlet 22 and the pulse detonation tubes 30. In certain embodiments, the flow rate through each bypass valve 36 may be particularly adjusted to establish a desired fluid flow rate through the PDE 10.

Similar to the inlet 12, the exit nozzle 16 includes a converging section 38, a throat 40 and a diverging section 42. The nozzle 16 is configured to accelerate the high-pressure subsonic exhaust gas 32 to supersonic speeds (i.e., low-pressure supersonic exhaust gas 44), thereby generating thrust. For example, the converging section 38 may be shaped to increase the velocity of the exhaust gas 32 such that sonic flow (i.e., flow at the speed of sound) is achieved at the throat 40. If a sufficient exhaust gas pressure is generated, a supersonic flow of exhaust gas 44 will be established within the diverging section 42. Furthermore, the diverging section 42 may be shaped to further increase the velocity of the supersonic exhaust gas 44. Such an exit nozzle configuration may generate considerable thrust.

The PDE 10 described above does not include a turbine or a mechanical compressor. As will be appreciated, mechanical compressors include various components driven to move by an external power source. As an airflow enters the mechanical compressor, movement of the components with respect to one another compresses the airflow. Such mechanical compressors may include axial compressors, centrifugal compressors, reciprocating compressors, screw compressors, and scroll compressors, for example. Because the illustrated PDE 10 does not include a mechanical compressor or a turbine, the PDE 10 may be described as a “pure” PDE. In the illustrated embodiment, the inlet 12 is configured to provide an airflow 28 to the pulse detonation tubes 30 having a sufficient pressure to facilitate detonation reactions. Specifically, the pressure of the airflow 28 into each pulse detonation tube 30 is greater than the pressure within the tube 30 when the respective air valve is in an open position. Consequently, a mechanical compressor, which may be employed in alternative PDE configurations to provide pressurized air to the pulse detonation tubes 30, is obviated. In addition, a turbine, which may be employed to drive the mechanical compressor, is also obviated. Because the illustrated pure PDE does not include a mechanical compressor or a turbine, the PDE 10 may provide enhanced efficiency due to the elimination of rotational energy losses associated with driving the turbine and mechanical compressor.

In the illustrated embodiment, the PDE 10 includes a controller 46 configured to control operation of the PDE 10. The controller 46 is configured to receive signals indicative of a desired operating parameter of the PDE 10 and/or a measured internal parameter of the PDE 10. As illustrated, the PDE 10 includes a first sensor 48 configured to measure temperature and/or pressure upstream of the inlet 12, a second sensor 50 configured to measure temperature and/or pressure downstream from the inlet 12, a third sensor 52 configured to measure temperature and/or pressure upstream of the exit nozzle 16, and a fourth sensor 54 configured to measure temperature and/or pressure downstream from the exit nozzle 16. Each sensor 48, 50, 52 and 54 is communicatively coupled to the controller 46 and configured to transmit signals to the controller 46 indicative of measured internal parameters (e.g., temperatures and/or pressures) within the PDE 10. While four sensors 48, 50, 52 and 54 are included in the illustrated embodiment, it should be appreciated that alternative embodiments may include more or fewer sensors configured to measure temperature, pressure and/or other internal parameters. For example, certain embodiments may include sensors coupled to the pulse detonation tubes 30, and configured to measure tube skin temperature, detonation wave speed and/or other parameters associated with operation of the pulse detonation tubes 30. The controller 46 is also communicatively coupled to a user interface 56 configured to provide a desired operating parameter (e.g., thrust, specific impulse and/or exhaust gas composition) to the controller 46.

In the certain embodiments, the controller 46 is communicatively coupled to a vehicle controller 57. As will be appreciated, the vehicle controller 57 may be configured to control operation of a vehicle (e.g., aircraft) powered by the PDE 10. The vehicle controller 57 may be configured to receive signals indicative of measured air speed, vehicle altitude, and/or other vehicle operation parameters, and to relay these signals to the controller 46. The controller 46, in turn, may control operation of the PDE 10 based on the signals indicative of a desired operating parameter, a measured internal parameter and/or a vehicle operation parameter.

The controller 46 is configured to adjust a fluid flow through the PDE 10 and/or a fluid flow through at least one of the pulse detonation tubes 30 based on the signals. In the illustrated embodiment, the controller 46 is communicatively coupled to the inlet 12, the bypass valves 36, the pulse detonation tubes 30, and the exit nozzle 16. In certain embodiments, the controller 46 may be configured to adjust the fluid flow through the PDE 10 by varying the geometry of the inlet 12, by varying the geometry of the exit nozzle 16, by varying the geometry of at least one pulse detonation tube nozzle 34, by varying a firing pattern of the pulse detonation tubes 30, by selectively deactivating at least one pulse detonation tube 30, and by selectively opening and closing certain bypass valves 36. As discussed in detail below, the controller 46 may also be configured to adjust the fluid flow through at least one of the pulse detonation tubes 30 by varying an opening frequency of an air valve disposed at an upstream end of the pulse detonation tube 30, by varying an opening duration of the air valve, by varying an injection pressure of fuel into the pulse detonation tube 30, by varying an injection duration of the fuel, by varying a time difference between opening the air valve and injecting the fuel, and by varying a time difference between opening the air valve and igniting a fuel-air mixture within the pulse detonation tube 30. By monitoring measured internal parameters of the PDE 10, the controller 46 may adjust fluid flow through the PDE 10 and/or fluid flow through at least one of the pulse detonation tubes 30 to compensate for changing environmental conditions. In addition, the controller 46 may adjust fluid flow through the PDE 10 and/or fluid flow through at least one of the pulse detonation tubes 30 to establish a desired operating parameter (e.g., thrust, specific impulse and/or exhaust gas composition) input through the user interface 56.

Certain PDE inlets 12 have a substantially rectangular cross-section. Such inlets 12 may include a first set of flat plates defining the upper and lower portions of the converging section 22, and a second set of flat plates defining the upper and lower portions of the diverging section 26. The throat 24 is formed at the intersection between the first set and second set of flat plates. In this configuration, the area of the throat 24 may be adjusted by varying the angle of each flat plate relative to the airflow 18. For example, an actuator may be configured to drive the upper and lower plates toward one another at the throat 24 to decrease throat area, and to drive the upper and lower plates away from one another at the throat to increase throat area. As previously discussed, establishing a desired inlet geometry may provide a high-pressure subsonic airflow 28 to the pulse detonation combustor 14, while substantially reducing or eliminating shockwave formation. Accordingly, the controller 46 may be communicatively coupled to the actuator, and configured to instruct the actuator to drive the plates to establish the desired throat area.

As will be appreciated, the desired throat area may be at least partially dependent on the temperature and pressure of the airflow 18 upstream of the inlet 12, and the temperature and pressure of the airflow 28 downstream from the inlet 12. Consequently, the controller 46 may be configured to receive signals from the first sensor 48 and/or the second sensor 50 indicative of the temperature and/or pressure at the respective sensor locations. The controller 46 may then compute the desired throat area based on the signals, and instruct the actuator to adjust the position of the plates to achieve the desired throat area. In this manner, the controller 46 may facilitate efficient operation of the PDE 10 (e.g., reduction in shockwave formation) despite variations in environmental conditions (e.g., temperature and/or pressure) and/or variations in internal flow through the PDE 10. While varying the throat area is described above, it should be appreciated that other variations in the inlet geometry (e.g., inlet exit area, shape of the converging section 22, shape of the diverging section 26, etc.) may be employed in alternative embodiments.

Similarly, the controller 46 may be configured to vary the geometry of the exit nozzle 16 based on a desired operating parameter of the PDE 10 and/or a measured internal parameter of the PDE 10. As previously discussed, establishing a desired exit nozzle geometry may generate a supersonic exhaust gas flow 44, while substantially reducing or eliminating shockwave formation. Accordingly, the controller 46 may be communicatively coupled to actuators within the exit nozzle 16 that regulate throat area and/or nozzle exit area. For example, the desired throat area may be at least partially dependent on the temperature and pressure of the exhaust gas flow 32 upstream of the nozzle 16, and the temperature and pressure of the exhaust gas flow 44 downstream from the nozzle 16. Consequently, the controller 46 may be configured to receive signals from the third sensor 52 and/or the fourth sensor 54 indicative of the temperature and/or pressure at the respective sensor locations. The controller 46 may then compute the desired throat area based on the signals, and instruct the actuators to vary the geometry of the exit nozzle 16 to achieve the desired throat area. In this manner, the controller 46 may facilitate efficient operation of the PDE 10 (e.g., reduction in shockwave formation) despite variations in environmental conditions (e.g., temperature and/or pressure) and/or variations in internal flow through the PDE 10.

In addition, the controller 46 may adjust the area of the nozzle exit to facilitate efficient operation of the PDE 10. For example, the user interface 56 may enable an operator to input a throttle setting. As will be appreciated, a higher throttle setting will establish a higher flow rate of exhaust gas 32 to the exit nozzle 16. The higher flow rate will generate a higher pressure within the converging section 38, thereby inducing the formation of expansion waves downstream from the exit nozzle 16. This condition may be known as under-expansion, and may decrease PDE efficiency due to the energy loss associated with the formation of the expansion waves. To compensate for the under-expansion, the controller 46 may instruct the actuators to increase the area of the nozzle exit, thereby further accelerating the flow of exhaust gas 44 and substantially reducing or eliminating the formation of expansion waves. In addition, the expanded nozzle exit will increase exhaust gas velocity, thereby increasing the specific impulse of the PDE 10. By adjusting the throat area and exit area of the exit nozzle 16, the controller 46 may respond to operator inputs and/or facilitate efficient operation of the PDE 10 despite variations in environmental conditions. While varying the throat area and exit area are described above, it should be appreciated that other variations in the exit nozzle geometry (e.g., nozzle inlet area, shape of the converging section 38, shape of the diverging section 42, etc.) may be employed in alternative embodiments.

Furthermore, the controller 46 may be configured to vary the firing pattern of the pulse detonation tubes 30 based on a desired operating parameter of the PDE 10 and/or a measured internal parameter of the PDE 10. For example, the controller 46 may be configured to increase the firing frequency in response to a higher throttle input from the user interface 56. The increased firing frequency will generate additional thrust due to the increased exhaust gas generated by the pulse detonation tubes 30. In addition, the controller 46 may be configured to increase the number of pulse detonation tubes 30 fired simultaneously in response to a higher throttle input. For example, if an operator inputs a low throttle setting into the user interface 56, the controller 46 may fire each pulse detonation tube 30 individually. However, if a higher throttle setting is input, the controller 46 may instruct 2, 3, 4, 5, or more pulse detonation tubes 30 to fire simultaneously, thereby generating additional thrust. The controller 46 may also be configured to monitor the temperature of the exhaust gas 32 via the third sensor 52. If the temperature of the exhaust gas 32 exceeds a desired threshold, the controller 46 may decrease the firing frequency to compensate. While varying the frequency and number of tubes 30 fired simultaneously is described above, it should be appreciated that other firing pattern variations (e.g., firing order, etc.) may be employed in alternative embodiments.

In addition, the controller 46 may be configured to selectively deactivate at least one pulse detonation tube 30 to adjust the flow through the PDE 10. For example, if an operator inputs a lower throttle setting into the user interface 56, the controller 46 may deactivate one or more pulse detonation tubes 30 to decrease the thrust produced by the PDE 10. When a pulse detonation tube 30 is deactivated, the controller 46 may instruct the air valve to transition to an open position such that the air flow may pass through the tube 30. By way of example, if a 50% throttle setting is input into the user interface 56, the controller 46 may deactivate 50% of the pulse detonation tubes 30 to establish the desired throttle setting. The controller 46 may also be configured to selectively open and close certain bypass valves 36 to adjust flow through the PDE 10. As previously discussed, if a higher thrust is generated, the pulse detonation tubes 30 will expel a larger quantity of exhaust gas 32. In such a configuration, the bypass valves 36 may be transitioned to a closed position because the exhaust gas 32 expelled by the pulse detonation tubes 30 is sufficient to established a desired flow rate through the exit nozzle 16. However, if a lower thrust is desired, the pulse detonation tubes 30 will expel a smaller quantity of exhaust gas 32. Consequently, the bypass valves 36 may be transitioned to an open position to facilitate increased flow through the exit nozzle 16. In certain embodiments, the flow rate through each bypass valve 36 may be particularly adjusted to establish a desired fluid flow rate through the PDE 10.

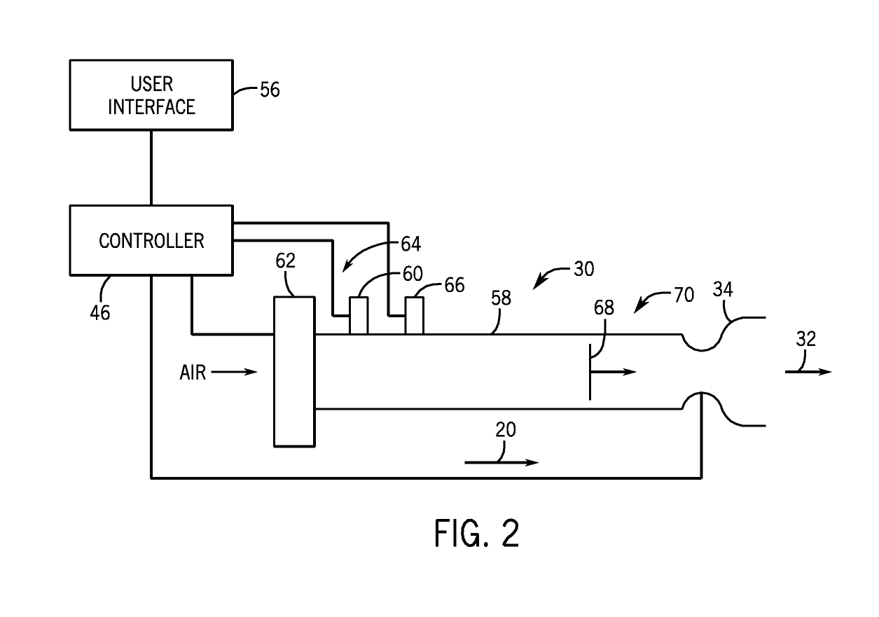

FIG. 2 is a schematic diagram of an embodiment of a pulse detonation tube 30 that may be used within the PDE 10 of FIG. 1. In the present embodiment, the pulse detonation tube 30 includes a base tube 58 configured to facilitate formation and propagation of a detonation wave. The pulse detonation tube 30 also includes at least one fuel injector 60 (e.g., 1, 2, 3, 4, 5, 6, 7, 8, 9, 10, or more), which feeds fuel to a combustion zone located within the base tube 58. Furthermore, the pulse detonation tube 30 includes an air valve 62 disposed to an upstream region 64 of the base tube 58. The air valve 62 is configured to inject discrete air pulses into the base tube 58. The fuel injector 60 is configured to inject fuel into each of the air pulses to establish a fuel-air mixture suitable for detonation. An ignition source 66 then detonates the fuel-air mixture, thereby forming a detonation wave 68 that propagates through the base tube 58 in the downstream direction 20. Specifically, the detonation wave 68 passes through a downstream region 70 of the base tube 58, e.g., a region downstream from the ignition source 66. Exhaust gas 32 from the detonation reaction exits the pulse detonation tube 30 through the nozzle 34. The exhaust gas 32 may flow directly to ambient to produce thrust or may be combined with the exhaust gas from other pulse detonation tubes 30 and directed toward the exit nozzle 16 of the PDE 10.

While an ignition source 66 is employed in the illustrated embodiment, it should be appreciated that alternative embodiments may include other mechanisms to initiate the detonation reaction. For example, certain pulse detonation tubes may utilize a high energy detonation initiation system configured induce detonation by introducing a shockwave to the fuel-air mixture. Such a detonation initiation mechanism may be known as a shock-to-detonation (SDT) system. For example, in certain embodiments, a second pulse detonation tube may be employed to generate a shockwave that initiates the detonation reaction within the illustrated tube 30. Such a configuration may decrease the tube length sufficient for detonation wave formation, thereby enabling a PDE 10 to employ shorter pulse detonation tubes 30.

As illustrated, the controller 46 is communicatively coupled to the fuel injector 60, the air valve 62, the ignition source 66 and the nozzle 34. The controller is configured to adjust the fluid flow through the pulse detonation tube 30 by varying an opening frequency of the air valve 62, an opening duration of the air valve 62, an injection pressure of the fuel, an injection duration of the fuel, a time difference between opening the air valve 62 and injecting the fuel, and/or a time difference between opening the air valve 62 and igniting the fuel-air mixture. By varying the flow through each pulse detonation tube 30, the controller 46 may facilitate efficient operation of the PDE 10 despite variations in environmental conditions (e.g., temperature and/or pressure) and/or variations in internal flow through the PDE 10.

In certain embodiments, the controller 46 is configured to vary an opening frequency of the air valve 62 to adjust the fluid flow through the pulse detonation tube 30. As previously discussed, when the air valve 62 is in the open position, compressed air 28 will flow into the base tube 58. Consequently, increasing the opening frequency of the air valve 62 establishes more frequent air pulses through the tube 58. By injecting fuel into each of these air pulses and detonating the fuel-air mixture, the firing frequency of the tube will increase as the air valve opening frequency increases. As the firing frequency increases, the time-averaged exhaust gas flow rate for a particular pulse detonation tube 30 will also increase. Therefore, if a higher flow rate is desired from a particular pulse detonation tube 30, the controller 46 may increase the opening frequency of the respective air valve 62 to facilitate additional detonation reactions. While varying the opening frequency to adjust the exhaust gas flow rate is described above, it should be appreciated that the opening frequency may be varied to adjust other pulse detonation tube flow parameters in alternative embodiments.

The controller 46 may also be configured to adjust the duration that the air valve 62 remains open during each pulse. For example, by increasing the duration, more air will flow into the base tube 58 prior to each detonation. The larger air charge may enable additional fuel to be injected into the tube 58, thereby increasing the fill fraction (i.e., fraction of the pulse detonation tube 30 filled with the fuel-air mixture). As a result, each detonation reaction will generate additional exhaust gas, thereby increasing the thrust produced by the PDE 10. While varying the opening duration to adjust the fill fraction is described above, it should be appreciated that the opening duration may be varied to adjust other pulse detonation tube flow parameters in alternative embodiments.

In addition, the controller 46 may be configured to vary a fuel injection pressure and/or a fuel injection duration to adjust the fluid flow through the pulse detonation tube 30. In certain embodiments, the fuel injector 60 includes a valve configured to vary the pressure of the fuel injected into the base tube 58. As will be appreciated, for a particular fuel injection duration, a higher fuel pressure may provide more fuel to the base tube 58 than a lower fuel pressure. Consequently, the controller 46 may be configured to control the fuel injector valve to provide a desired quantity of fuel to the base tube 58. Similarly, the controller 46 may be configured to adjust the duration that the valve remains open to vary the quantity of fuel provided to the base tube 58. For example, if the third sensor 52 determines that the temperature of the exhaust gas 32 is greater than desired, the controller 46 may decrease the fuel pressure and/or decrease the fuel injection duration to establish a fuel-lean mixture ratio (i.e., a fuel-air mixture having more air than is sufficient for complete combustion). As a result, the reduced fuel flow will tend to cool the exhaust gas 32, thereby decreasing the exhaust gas temperature to a desired level. In addition, the controller 46 may coordinate the reduced fuel flow with an increase in airflow (e.g., by increasing the opening duration of the air valve 62), thereby providing an increased exhaust gas flow rate to the exit nozzle 16. Furthermore, the exhaust gas composition may be adjusted by varying the fuel injection pressure and/or duration. While varying the fuel injection pressure and fuel injection duration to adjust the exhaust gas flow rate, temperature and composition are described above, it should be appreciated that the fuel injection pressure and fuel injection duration may be varied to adjust other pulse detonation tube flow parameters in alternative embodiments.

In further embodiments, the controller 46 may be configured to vary a time difference between opening the air valve 62 and injecting the fuel and/or a time difference between opening the air valve 62 and igniting the mixed fuel-air region to adjust the fluid flow through the pulse detonation tube 30. In certain embodiments, the controller may be configured to inject fuel into the base tube 58 at varying positions along the length of the air pulse. For example, the controller 46 may delay fuel injection relative to opening the air valve 62 to deliver the fuel into an upstream portion of the air pulse. Conversely, the controller 46 may accelerate fuel injection relative to opening the air valve 62 to deliver the fuel into a downstream portion of the air pulse. As will be appreciated, the dynamics of the detonation reaction are at least partially dependent on the distribution of the fuel within the air pulse. Consequently, the controller 46 may adjust the flow from the pulse detonation tube 30 by varying a time difference between opening the air valve 62 and injecting the fuel. In addition, the controller 46 may be configured to initiate the detonation reaction at various locations along the mixed fuel-air region. For example, the controller 46 may delay ignition of the fuel-air mixture until an upstream portion of the mixture is proximate to the ignition source 66. Alternatively, the controller 46 may initiate detonation of the fuel-air mixture when a downstream portion of the fuel-air mixture is proximate to the ignition source 66. As will be appreciated, the deflagration-to-detonation transition (DDT) is at least partially dependent on the location where the detonation is initiated. Therefore, the controller 46 may adjust the flow from the pulse detonation tube 30 by varying a time difference between opening the air valve 62 and igniting the mixed fuel-air region.

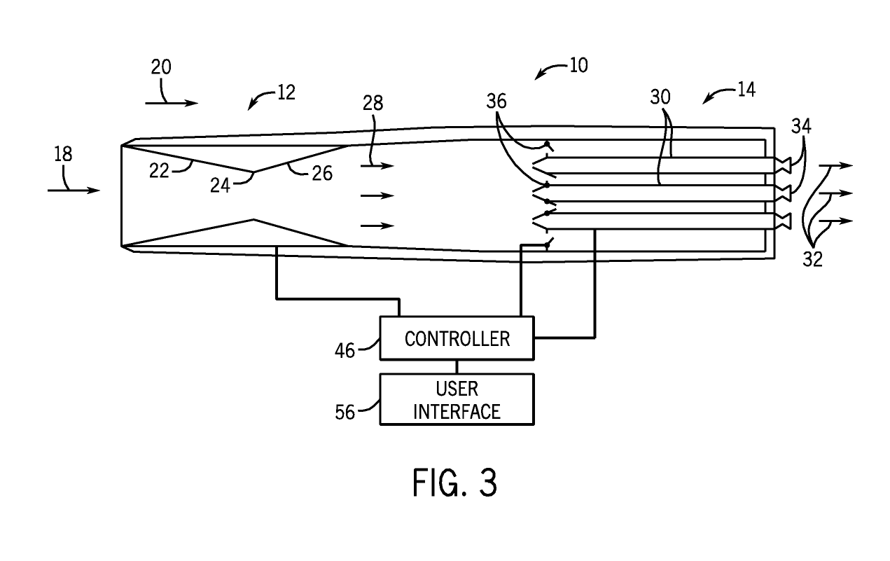

FIG. 3 is a schematic diagram of an embodiment of a PDE 10 in which the pulse detonation tubes 30 are configured to exhaust directly to ambient. As illustrated, the PDE 10 does not include an exit nozzle, such as the exit nozzle 16 described above with reference to FIG. 1. Instead, the pulse detonation tube nozzles 34 are configured to direct the flow of exhaust gas 32 into the ambient air to produce thrust. As will be appreciated, the shape and configuration of the illustrated nozzles 34 may be significantly different than nozzles configured to provide an exhaust flow to an exit nozzle 16.

Similar to the PDE 10 described above with reference to FIG. 1, the controller 46 is communicatively coupled to the inlet 12, the bypass valves 36 and the pulse detonation tubes 30. Consequently, the controller 46 may adjust fluid flow through the PDE 10 and the pulse detonation tubes 30 in response to varying environmental conditions and/or operator input. In certain embodiments, the controller 46 is configured to adjust the fluid flow through the PDE 10 at a first rate, and to adjust the fluid flow through the pulse detonation tubes 30 at a second rate, faster than the first rate. For example, the controller 46 may adjust the geometry of the inlet 12, the pulse detonation tube firing pattern and/or the geometry of the pulse detonation tube nozzles 34 every 1, 5, 10, 20, 50, or 100 milliseconds, or more. In addition, the controller 46 may adjust the air valve opening frequency, the air valve opening duration, the fuel injection pressure, the fuel injection duration, the fuel injection timing and/or the ignition timing of the pulse detonation tubes 30 every 100, 50, 20, 10, 5, or 1 microsecond, or less. In this manner, the controller 46 may effectively regulate the higher frequency flow variations within the pulse detonation tubes 30, and the lower frequency flow variations within the PDE 10.

In certain embodiments, the controller 46 may compute a target output for the pulse detonation tubes 30 at the first rate and control each component of the pulse detonation tubes 30 at the second rate. For example, if a higher thrust is desired, the controller 46 may adjust the inlet geometry, the pulse detonation tube nozzle geometry, and the bypass valve positions at the first rate. In addition, the controller may compute a desired flow rate from the pulse detonation tubes 30 at the first rate. Based on the desired flow rate from the pulse detonation tubes 30, the controller may adjust the air valve opening frequency, the air valve opening duration, the fuel injection pressure, the fuel injection duration, the fuel injection timing and the ignition timing of the pulse detonation tubes at the second rate, faster than the first rate. In this manner, the controller 46 may efficiently control the PDE 10, while utilizing less computational power than a controller configured to control every PDE component at the faster rate.

In further embodiments, the controller 46 is configured to adjust the fluid flow through the PDE 10 at a first rate, to adjust an aggregate of the fluid flows through the pulse detonation tubes 30 at a second rate, and to adjust the fluid flow through each pulse detonation tube 30 at a third rate, where the third rate is faster than the second rate, and the second rate is faster than the first rate. For example, the controller 46 may adjust the geometry of the inlet 12 and compute a desired aggregate flow rate from the pulse detonation tubes 30 at the first rate. Based on the desired aggregate flow rate, the controller 46 may adjust the positions of the bypass valves 36 and the nozzles 34, and compute a desired flow rate from each pulse detonation tube 30 at the second rate, faster than the first rate. Based on the desired pulse detonation tube flow rate, the controller 46 may adjust the air valve opening frequency, the air valve opening duration, the fuel injection pressure, the fuel injection duration, the fuel injection timing and the ignition timing of the pulse detonation tubes at the third rate, faster than the second rate. While two and three control rates are described above, it should be appreciated that the controller 46 may employ additional control rates (e.g., 4, 5, 6, or more) in alternative embodiments.

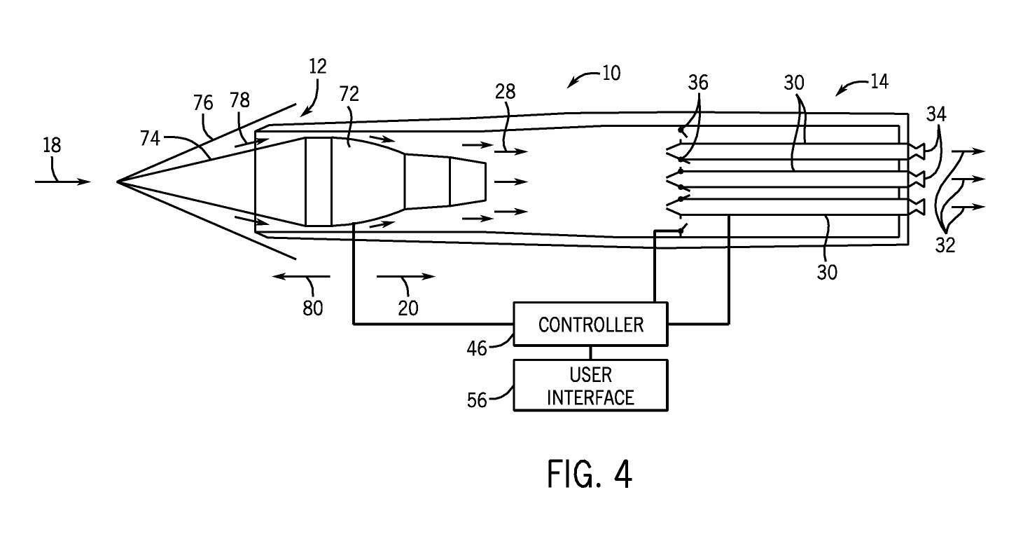

FIG. 4 is a schematic diagram of an embodiment of a PDE 10 in which the inlet 12 includes a movable spike 72. As illustrated, the movable spike 72 includes a angled nose 74 configured to induce formation of one or more oblique shockwaves 76. The oblique shockwaves 76 serve to transition a supersonic airflow 18 to a subsonic airflow 78 suitable for use within the pulse detonation tubes 30. As will be appreciated, the angle of the oblique shockwaves 76 will vary based on the speed of the PDE 10. Consequently, the moveable spike 72 is configured to translate in an upstream direction 80 and a downstream direction 20 to position the shockwaves 76 upstream of the inlet 12, thereby providing a flow of subsonic air 78 into the PDE 10. In the illustrated embodiment, the controller 46 is communicatively coupled to the movable spike 72 and configured to adjust the position of the movable spike 72 based on the speed of the PDE 10, the measured temperature and/or the measured pressure. As a result, a flow of high-pressure subsonic air 28 will be provided to the pulse detonation tubes 30, thereby facilitating efficient operation of the PDE 10.

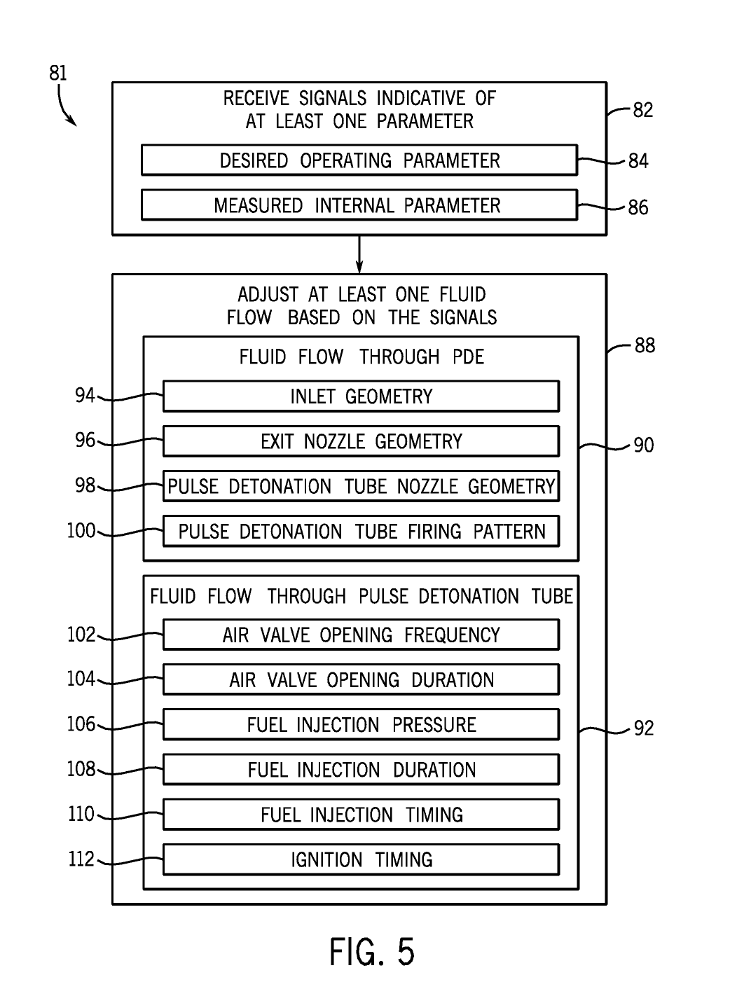

FIG. 5 is a flowchart of an embodiment of a method 81 for controlling a PDE 10. First, as represented by block 82, signals indicative of at least one parameter of the PDE 10 are received. As illustrated, the signals may include a first signal indicative of a desired operating parameter of the PDE 10, as represented by block 84, and a second signal indicative of a measured internal parameter of the PDE 10, as represented by block 86. For example, the controller 46 may receive the first signal indicative of the desired operating parameter of the PDE 10 (e.g., thrust, specific impulse and/or exhaust gas composition) from a user interface 56. In addition, the controller may receive the second signal indicative of the measured internal parameter of the PDE 10 from the first sensor 48 configured to measure temperature and/or pressure upstream of the inlet 12, the second sensor 50 configured to measure temperature and/or pressure downstream from the inlet 12, the third sensor 52 configured to measure temperature and/or pressure upstream of the exit nozzle 16, and the fourth sensor 54 configured to measure temperature and/or pressure downstream from the exit nozzle 16.

Next, as represented by block 88, at least one fluid flow is adjusted based on the signals. As illustrated, the fluid flows include a first fluid flow through the PDE, as represented by block 90, and a second fluid flow through at least one pulse detonation tube, as represented by block 92. A variety of techniques may be employed, either individually or in combination, to adjust the fluid flow through the PDE 10. First, as represented by block 94, a geometry of the inlet 12 may be varied. For example, the throat area may be increased or decreased to vary flow through the inlet 12, or the movable spike 72 may be adjusted to position the shockwaves 76 at a desired location. Furthermore, a geometry of the exit nozzle 16 may be varied, as represented by block 96. For example, the area of the throat and/or the area of the nozzle exit may be adjust to achieve a desired exhaust gas velocity. In addition, a geometry of at least one nozzle 34 of the pulse detonation tubes 30 may be varied, as represented by block 98. Adjusting the geometry of the nozzles 34 may facilitate increased or decreased exhaust gas flow into the PDE exit nozzle 16. A firing pattern of the pulse detonation tubes 30 may also be varied to adjust the fluid flow through the PDE, as represented by block 100. For example, the number of pulse detonation tubes fired simultaneously may be increased to provide additional thrust.

In addition, a variety of techniques may be employed, either individually or in combination, to adjust the fluid flow through each pulse detonation tube 30. First, as represented by block 102, an opening frequency of the air valve 62 may be varied. For example, if a higher flow rate is desired from a particular pulse detonation tube 30, the controller 46 may increase the opening frequency of the respective air valve 62 to facilitate additional detonation reactions. Furthermore, an opening duration of the air valve 62 may be varied, as represented by block 104. For example, the fuel-air mixture ratio may be adjusted by varying the opening duration of the air valve 62 while maintaining a constant fuel flow rate into the pulse detonation tube 30. An injection pressure of the fuel and an injection duration of the fuel may also be varied, as represented by blocks 106 and 108, respectively. For example, the controller 46 may increase the fuel pressure and/or increase the fuel injection duration to establish a fuel-rich mixture ratio, thereby decreasing the exhaust gas temperature to a desired level. Finally, a time difference between opening the air valve 62 and injecting the fuel and a time difference between opening the air valve 62 and igniting the mixed fuel-air region may be varied, as represented by blocks 110 and 112, respectively. For example, the controller 46 may delay fuel injection relative to opening the air valve 62 to deliver the fuel into an upstream portion of the air pulse, thereby alternating the dynamics of the detonation reaction. In addition, the controller 46 may delay ignition of the fuel-air mixture until an upstream portion of the mixture is proximate to the ignition source 66, thereby influencing the DDT and the exhaust flow from the pulse detonation tube 30.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A pulse detonation engine (PDE) comprising:
a controller configured to receive signals indicative of at least one of a desired operating parameter of the PDE and a measured internal parameter of the PDE, and to adjust at least one of a first fluid flow through the PDE and a second fluid flow through at least one of a plurality of pulse detonation tubes disposed within the PDE based on the signals;
wherein the PDE does not comprise a turbine or a mechanical compressor.

2. The PDE of claim 1, wherein the desired operating parameter of the PDE comprises at least one of a thrust, a specific impulse, and a composition of an exhaust gas.

3. The PDE of claim 1, wherein the measured internal parameter of the PDE comprises at least one of a pressure upstream of the plurality of pulse detonation tubes, a temperature upstream of the plurality of pulse detonation tubes, a pressure downstream from the plurality of pulse detonation tubes, and a temperature downstream from the plurality of pulse detonation tubes.

4. The PDE of claim 1, wherein the controller is configured to receive signals indicative of a vehicle operation parameter, and to adjust at least one of the first fluid flow through the PDE and the second fluid flow through at least one of the plurality of pulse detonation tubes disposed within the PDE based on the signals indicative of the vehicle operation parameter.

5. The PDE of claim 1, wherein the controller is configured to vary at least one of a geometry of an inlet positioned upstream of the plurality of pulse detonation tubes, and a geometry of an exit nozzle positioned downstream from the plurality of pulse detonation tubes to adjust the first fluid flow through the PDE.

6. The PDE of claim 1, wherein the controller is configured to vary a geometry of a nozzle coupled to a pulse detonation tube to adjust the first fluid flow through the PDE.

7. The PDE of claim 1, wherein the controller is configured to vary a firing pattern of the plurality of pulse detonation tubes to adjust the first fluid flow through the PDE.

8. The PDE of claim 1, wherein the controller is configured to vary at least one of an opening frequency of an air valve disposed at an upstream end of the pulse detonation tube, an opening duration of the air valve, an injection pressure of fuel into the pulse detonation tube, an injection duration of the fuel, a time difference between opening the air valve and injecting the fuel, and a time difference between opening the air valve and igniting a fuel-air mixture within the pulse detonation tube to adjust the second fluid flow through the pulse detonation tube.

9. The PDE of claim 1, wherein the controller is configured to adjust the first fluid flow through the PDE at a first rate, and to adjust the second fluid flow through at least one of the plurality of pulse detonation tubes at a second rate, wherein the second rate is faster than the first rate.

10. The PDE of claim 1, wherein the controller is configured to adjust the first fluid flow through the PDE at a first rate, to adjust an aggregate of the second fluid flows through the plurality of pulse detonation tubes at a second rate, and to adjust the second fluid flow through each pulse detonation tube at a third rate, wherein the third rate is faster than the second rate, and the second rate is faster than the first rate.

11. A pulse detonation engine (PDE) comprising:
an inlet disposed at an upstream end of the PDE and configured to receive an airflow from ambient air;
a plurality of pulse detonation tubes positioned downstream from the inlet, wherein each pulse detonation tube is configured to receive the airflow from the inlet, and wherein the PDE does not comprise a mechanical compressor positioned between the inlet and the plurality of pulse detonation tubes; and
a controller configured to receive signals indicative of at least one of a desired operating parameter of the PDE and a measured internal parameter of the PDE, and to adjust at least one of a first fluid flow through the PDE and a second fluid flow through at least one of the plurality of pulse detonation tubes based on the signals.

12. The PDE of claim 11, comprising a plurality of bypass valves positioned between adjacent pulse detonation tubes, wherein the controller is configured to selectively open and close each bypass valve to adjust the first fluid flow through the PDE.

13. The PDE of claim 11, wherein the controller is configured to selectively deactivate at least one pulse detonation tube to adjust the first fluid flow through the PDE.

14. The PDE of claim 11, comprising an exit nozzle positioned downstream from the plurality of pulse detonation tubes, wherein the controller is configured to vary a geometry of the exit nozzle to adjust the first fluid flow through the PDE.

15. The PDE of claim 11, wherein each pulse detonation tube comprises:
an air valve disposed at an upstream end of the pulse detonation tube and configured to emanate an air pulse in a downstream direction;
a fuel injector configured to inject fuel into each air pulse to establish a mixed fuel-air region; and
an ignition source configured to ignite the mixed fuel-air region;
wherein the controller is configured to vary at least one of an opening frequency of the air valve, an opening duration of the air valve, an injection pressure of the fuel, an injection duration of the fuel, a time difference between opening the air valve and injecting the fuel, and a time difference between opening the air valve and igniting the mixed fuel-air region to adjust the second fluid flow through the pulse detonation tube.

16. A method for operating a pulse detonation engine (PDE) which does not include a mechanical compressor or a turbine, comprising:
receiving signals indicative of at least one of a desired operating parameter of the PDE and a measured internal parameter of the PDE; and
adjusting at least one of a first fluid flow through the PDE and a second fluid flow through at least one of a plurality of pulse detonation tubes disposed within the PDE based on the signals.

17. The method of claim 16, wherein adjusting the first fluid flow comprises at least one of varying a geometry of an inlet positioned upstream of the plurality of pulse detonation tubes, varying a geometry of an exit nozzle positioned downstream from the plurality of pulse detonation tubes, varying a geometry of at least one nozzle of the plurality of pulse detonation tubes and varying a firing pattern of the plurality of pulse detonation tubes.

18. The method of claim 16, wherein adjusting the second fluid flow comprises at least one of varying an opening frequency of an air valve disposed at an upstream end of the pulse detonation tube, varying an opening duration of the air valve, varying an injection pressure of fuel into the pulse detonation tube, varying an injection duration of the fuel, varying a time difference between opening the air valve and injecting the fuel, and varying a time difference between opening the air valve and igniting a fuel-air mixture within the pulse detonation tube.

19. The method of claim 16, comprising adjusting the first fluid flow through the PDE at a first rate, and adjusting the second fluid flow through at least one of the plurality of pulse detonation tubes at a second rate, wherein the second rate is faster than the first rate.

20. The method of claim 16, comprising adjusting the first fluid flow through the PDE at a first rate, adjusting an aggregate of the second fluid flows through the plurality of pulse detonation tubes at a second rate, and adjusting the second fluid flow through each pulse detonation tube at a third rate, wherein the third rate is faster than the second rate, and the second rate is faster than the first rate.
